(19) United States
(12) Patent Application Publication
(10) Pub. No.: US 2015/0156534 A1
(43) Pub. Date: Jun. 4, 2015

(54) Antenna Sub-system for Receiving Multiple ATSC TV Signals

(71) Applicant: Mark A Gintis, Boca Raton, FL (US)

(72) Inventor: Mark A Gintis, Boca Raton, FL (US)

(21) Appl. No.: 14/479,280

(22) Filed: Sep. 6, 2014

Related U.S. Application Data
(60) Provisional application No. 61/875,649, filed on Sep. 9, 2013.

(51) Int. Cl. H04N 21/426; H04H 40/27; H04N 5/781; H04H 20/71

(52) U.S. Cl. CPC H04N 21/4263; H04H 20/71; H04H 40/27; H04N 5/781

(57) ABSTRACT

An antenna sub-system apparatus for receiving a plurality of over the air television broadcast signals comprising a plurality of antennas packaged together capable of receiving broadcast signals, each antenna capable of receiving independent signals, and an active electronics assembly, wherein the antennas are secured together, include a coupling means for connecting to the active electronics assembly, and, a plurality of amplifier/tuner elements, one for each antenna.

### FIELD OF THE INVENTION

The present invention related generally to antenna and tuner systems, and more particularly to an antenna tuner sub-system that receive multiple ATSC TV signals for the purpose of viewing and/or recording to disk for time shifted TV entertainment viewing.

### BACKGROUND OF THE INVENTION

A variety of networks including ABC, CBS, CW and USA, to name just a few, are broadcasting their programming digitally in 1080i which is capable of being captured for minimal or no charge by an antenna. The use of antennas has become rare, as consumers have increased their demands for customized options, channels, programming etc. This has kept the various digital and satellite television service providers thriving as they provide options like multiple DVR capabilities. There was no way to cost effectively provide households the ability to watch television broadcast directly by the networks in 1080i and simultaneously record multiple television shows.

Furthermore, while the networks discussed provide true high definition television broadcast in 1080i, large cable and satellite providers are only able to offer service between 720 and 1080i.

### SUMMARY OF THE INVENTION

This invention addresses that need to receive multiple over the air television broadcast signals at the same time. The invention comprises an apparatus and a method.

The apparatus is an antenna sub-system apparatus for receiving a plurality of over the air television broadcast signals, each having a first resolution. The apparatus comprises a passive antenna assembly and an active electronics assembly. The passive antenna assembly comprises at least two antennas packaged together and configured to receive over the air television broadcast signals, each antenna able to receive an independent over the air television signal. The active electronics assembly is configured to communicate with the at least two antennas and a digital video recorder, and comprises an amplifier for each antenna in communication with the antenna and a tuner connected to each amplifier.

The method is a method of recording multiple over the air television broadcast signals and comprises five steps. The first step is providing at least two over the air television broadcast signals each with a first resolution. The second step is providing the antenna sub-system apparatus for receiving a plurality of over the air television broadcast signals as described above. The third step is providing a digital recording device that is attached to all of the tuners of the active electronic assembly. The fourth step is receiving at least two independent over the air television broadcast signals each with a first resolution. The fifth step is conveying each over the air television broadcast signal to a digital video recorder to record each with a second resolution.

The invention has two parts: the passive antenna assembly and the active electronics assembly. This summary defines three items. The above two parts and the synergistic performance of the two parts acting as a third item with performance better than the expected sum of the first two parts.

The invention has at least two benefits. First, the present invention allows a household cost effectively to watch television broadcast directly by the networks in 1080i and simultaneously record multiple television shows. Second, the present invention not only allows for the viewing of cost effective television broadcast directly by the network, but also provides better clarity and sharpness of the show.

### BRIEF DESCRIPTION OF THE DRAWINGS

FIG. 1 is a schematic diagram of an embodiment of an antenna tuner sub-system of the present invention.

While the invention is amenable to various modifications and alternative forms, specifics have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION OF SOME EMBODIMENTS OF THE INVENTION

The invention has two parts: the passive antenna assembly and the active electronics assembly. This summary defines three items. The above two parts and the synergistic performance of the two parts acting as a third item with performance better than the expected sum of the first two parts.

It is believed by the inventor that there is no prior art in the antenna field of design or tuner field of design because it is not possible to buy the invention in any form and many manufacturers of similar components have neither heard of such parts or items nor do they have any idea(s) of how to solve the problem(s) associated with the design of a multi-tuner array antenna, even though they are (all) in a business where such a design breakthrough would be very profitable.

The problem is that Digital Video Recorders (DVRs) that receive cable-based QAM (or IPTV, or satellite-based) signals and record two to six channels are common place. This is a relatively easy task because there is more than a necessary QAM (or, other) TV signal on the cable to split it two to six ways and tune adequately, each channel with a separate tuner. ATSC TV, A.K.A. broadcast, over the air (OTA) TV, is different. ATSC antennas pick up a very small signal, usually close to their noise level, which is then sent to an amplifier to raise the signal level and lower the noise level. That processed signal is then sent to a tuner. If there is a need to record two channels at once then the signal must be split in two. Splitting can be done before or after amplification, however the results are the same. The signal level is split in half or less and/or the noise is doubled or worse. If four recordings are to be made simultaneously then the same problem persists. In general, for the case of four channels, less than one quarter of the signal is available and/or more than four times the noise is present. In some implementations there is less than one eighth of the signal and eight times as much noise. If the reception was fringe area reception then splitting the signal in half or in quarters makes the signal unusable. If the reception was strong then splitting the signal will cause the number and severity of reception artifacts to be higher. Under all circumstances the pairing of anything other than one antenna with one amplifier and one tuner is always less than optimal and sometimes makes the performance unusable.

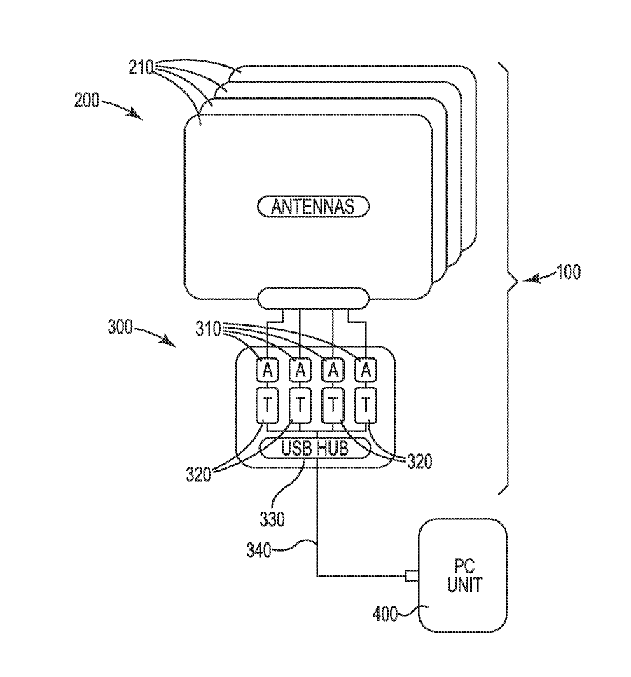

In brief summary, the solution is to pair only one antenna with only one amplifier and only one tuner. This mostly solves the problems stated above but is completely impractical. The implication of this solution is that there are, for example, four antennas, each with a coax cable to an amplifier and then a connection of the amplifiers to the tuners and all of the above to electrical power and to the DVR as illustrated in FIG. 1.

A novel solution to avoiding the obvious jumble of wire and electronic parts requires a two-fold approach. First, the multiple antennas must be made and look like one and the associated amplifiers and tuners and cables must be integrated into the antenna packaging optimally with only one cable from the “Integrated Antenna Array” to the DVR or TV device.

Until recently, there was no motivation to solve this problem. Multiple DVRs cost too much, NTSC video was of poor quality, HD ATSC with superior quality has mostly been ignored because of cable TV availability. However with the advent of the over $200 per month cable TV invoice ($2,400 per year, $26,400 for 11 years—the average cost and life of an automobile!), there is no longer lack of motivation to offer an alternative at any reasonable price.

Until recently, there was no antenna design that allowed multiple antennas to be made to look and be assembled and be packaged as one. The size of usable TV antennas made them too large. The size of usable TV antennas made them interact with each other so that the array did not work as the individual antennas did. Cellular phone technology and market demand have now taught antenna designers how to build the wide-band, small and flat antennas that are necessary to make phones that fit in our pockets work and work well. A few antenna companies have started to make flat, almost omni-directional, wide-band VHF to UHF antennas for ATSC TV viewing. These antennas act as ideal single channel elements in a wide-band, flat and small, multi-antenna array. The multi-antenna array is manufactured by “printing” each antenna physically on top of the other antenna array elements. Common RF engineering concepts would probably cause the antenna designer to mistakenly think that overlaying multiple antennas would cause one antenna to shield the next in the stack. This might be true if all the antennas were being used to tune the same channel. However, there is nearly no reason to ever do this. Each antenna is usually used to receive a different channel, so any resonance feedback from its respective amplifier and tuner combination has nearly no effect. In actual practice, using a Sencore SLM 1453 signal strength meter, measured results are that the stacking of these antennas cause a slight enhancement of the signal (on the order of 1 to 2 db). No explanation of this phenomenon is either offered or relevant to this summary of this invention.

Until recently, there have been few companies that were willing to invest the effort and outrageous expense to challenge how entertainment would be delivered to the average consumer. With over 100 million households wanting new choices that they can make about how their entertainment is delivered for their viewing pleasure, and, especially considering the public vested interest in the free FCC licenses that the TV entertainment industry has been endowed with, to broadcast ATSC TV, it is now time for a practical technical solution to the multi-antenna, multi-tuner, multi-DVR TV entertainment problem.

To these and to such other objects that may hereinafter appear, the present invention relates to an antenna tuner sub-system as described in detail in the following specification, taken together with the accompanying drawing, in which like numerals refer to like parts in which:

Multiple flat TV antennas are made with each of their feed wires at a different angle so that an integrated set of multiple amplifiers and multiple tuners can be connected directly to the antenna substrate and each of the tuners can be connected to an integrated and powered hub all integrated and packaged together. An additionally synergy is generated by the cables from the antennas to the amplifiers and the cables from the amplifiers to the tuners being omitted. Every cable and every connection is responsible for additional signal loss. Only one cable need be connected from the hub to the TV device. The one cable carries multiple tuned TV signals and power for all the “Integrated Antenna Array” components.

In an embodiment of the invention is described for illustration. A passive antenna assembly comprises Four Winegard Company FL-5000 FlatWave HDTV Indoor Digital Flat Antenna elements, made in the USA, that are taped together. The antennas may also be laminated or otherwise secured together. The antennas of the passive antenna assembly are attached to an active electronic assembly that comprises amplifiers and tuners and a hub assembly. Each of the four antennas is attached to each of 4 amplifier units that are in turn attached to each of 4 tuners. One such amplifier and tuner arrangement is a quad tuner card with amplifier sold as a KWorld UB435-Q tuner. These tuners, in turn, are connected, including power, to a 5 Gigabit per second, USB 3.0 powered hub, which, in turn, is connected through one USB cable to the New Choices Entertainment (NCE) Set Top Component TV device. The NCE component processes that multiple set of signals to either be recorded or displayed on the TV or both.

An example of the above embodiment of the invention is illustrated in FIG. 1, a schematic diagram of an embodiment of an antenna tuner sub-system of the present invention. An antenna sub-system (100) is shown comprising a passive antenna assembly (200) and an active electronic assembly (300), and is attached to a recording device (400). Four antennas (210) are individually attached to their own amplifier (310) and tuner (320). The four tuners are attached to a USB hub (330) that is, in turn, connected by a USB cable (340) to recording device 400.

The present invention uniquely combines at least two antennas, preferably four antennas as shown, together as a single unit. Preferably, these antennas are laminated or otherwise secured together. Each antenna includes a coupling means for connecting with an active electronics assembly. Preferably the active electronics assembly includes a tuner means, preferably a plurality of tuner cards. At least two, but preferably four tuner cards are designed within the assembly for accepting the coupling means. Each tuner card is in communication with an amplifier unit. There are an equal number of antennas as tuner means, such that each antenna communicates with one tuner means. The tuner cards and amplifier units are collectively coupled to a USB hub within the assembly. At least one connection means, preferably a USB cable, is in connection with the assembly and receiving device through the USB port, preferably a personal computer.

The method is a method of recording multiple over the air television broadcast signals and comprises five steps. The first step is providing at least two over the air television broadcast signals each with a first resolution. The second step is providing the antenna sub-system apparatus for receiving a plurality of over the air television broadcast signals as described above. The third step is providing a digital recording device that is attached to all of the tuners of the active electronic assembly. The fourth step is receiving at least two independent over the air television broadcast signals each with a first resolution. The fifth step is conveying each over the air television broadcast signal to a digital video recorder to record each with a second resolution.

Other modifications and changes made to fit particular operating requirements and environments will be apparent to those with ordinary skill in the art. Thus, the invention is not considered limited to the embodiments discussed for purposes of disclosure and covers all changes and modifications that do not constitute departures from the true spirit and scope of this invention.

What is claimed is:

1. An antenna sub-system apparatus for receiving a plurality of over the air television broadcast signals, each having a first resolution, comprising:
a passive antenna assembly comprising at least two antennas packaged together and configured to receive over the air television broadcast signals, each antenna able to receive an independent over the air television signal and
an active electronics assembly configured to communicate with the at least two antennas and a digital video recorder and, comprising:
an amplifier for each antenna in communication with the antenna, and
a tuner connected to each amplifier.

2. The antenna sub-system apparatus of claim 1, wherein the antennas are secured together.

3. The antenna sub-assembly apparatus of claim 1 wherein the apparatus is configured to convey an over the air television broadcast signal to the digital video recorder with a second resolution equal to that of the first resolution of the over the air television broadcast signal.

4. The antenna sub-assembly of claim 1 wherein the active electronic assembly further comprises a USB hub that is connected to all tuners.

5. A method of recording multiple over the air television broadcast signals, comprising the steps of:
a. providing at least two over the air television broadcast signals each with a first resolution;
b. providing an antenna sub-system apparatus for receiving a plurality of over the air television broadcast signals, comprising:
i. a passive antenna assembly comprising at least two antennas packaged together and configured to receive the over the air television broadcast signals, each antenna able to receive an independent over the air television broadcast signal and
ii. an active electronics assembly configured to communicate with the at least two antennas and a digital video recorder and, comprising:
an amplifier for each antenna and in communication with the antenna, and
a tuner connected to each amplifier;
c. providing a digital recording device that is attached to all of the tuners of the active electronic assembly
d. receiving at least two independent over the air television broadcast signals each with a first resolution;
e. conveying each over the air television broadcast signal to a digital video recorder to record each with a second resolution.

6. The method of claim 5 wherein the second resolution is the same as the first resolution.
